(19) United States
(12) Patent Application Publication
(10) Pub. No.: US 2026/0051109 A1
(43) Pub. Date: Feb. 19, 2026

(54) SUCCESSIVE COLOR FIELDS THAT DISPLAY A VIRTUAL OBJECT IN ARTIFICIAL REALITY

(71) Applicant: Meta Platforms Technologies, LLC, Menlo Park, CA (US)

(72) Inventor: Morgyn Taylor, Danville, CA (US)

(21) Appl. No.: 19/299,280

(22) Filed: Aug. 13, 2025

Related U.S. Application Data
(60) Provisional application No. 63/682,974, filed on Aug. 14, 2024.

(51) Int. Cl. G06T 15/04; G06F 3/01; G06T 15/20; G06T 19/00

(52) U.S. Cl. CPC G06T 15/04; G06F 3/012; G06F 3/013; G06T 15/20; G06T 19/006

(57) ABSTRACT

Aspects of the present disclosure are directed to displaying color fields over time by an artificial reality system. A method includes causing a head-wearable device worn by a user to present a virtual object by successively displaying a plurality of color fields including presenting a first color field and a second color field at a first display position so that the virtual object is at a world-locked location as viewed by the user from a first perspective. The method includes, in accordance with a determination, based on user motion data, that misalignment criteria are satisfied causing the head-wearable device to present the virtual object by successively displaying the plurality of color fields including presenting the first and/or second color fields of the virtual object at a second display position so that the virtual object is at the world-locked location as viewed by the user from a second perspective.

### RELATED APPLICATION

This application claims priority to U.S. Provisional Application Ser. No. 63/682,974, filed Aug. 14, 2024, entitled “Successive Color Fields That Display A Virtual Object In Artificial Reality,” which is incorporated herein by reference.

### TECHNICAL FIELD

The present disclosure is directed to displaying color fields over time by an artificial reality system.

### BACKGROUND

Systems can display virtual objects in artificial reality, such as augmented reality, mixed reality, and/or virtual reality. These systems can implement a variety of display techniques. For example, some systems can simultaneously display multiple color channels of a virtual object (e.g., red, green, and blue) while other systems can rapidly display different color fields of a virtual object over time. These display techniques utilize different hardware characteristics that balance advantages and disadvantages, such as cost, size (e.g., volume and/or weight), and functionality. Software display techniques can further improve the implementation of any given hardware to improve the user experience.

As such, there is a need to address one or more of the above-identified challenges. A brief summary of solutions to the issues noted above are described below.

### SUMMARY

One example of an augmented-reality/mixed-reality headset (referred to as an “extended-reality headset”) is described herein. The example extended-reality headset includes one or more imaging devices (e.g., cameras), one or more sensors (e.g., inertial measurement units, eye-tracking sensors, etc.), and a display (and/or display assembly, projector, waveguide, etc.). This example extended-reality headset includes one or more programs, where the one or more programs are stored in memory and configured to be executed by one or more processors. The one or more programs including instructions for performing operations. The operations include causing, at a first point in time, presentation of the virtual object by successively displaying a plurality of color fields including presenting a first color field at a first display position of the head-wearable device and a second color field at the first display position of the head-wearable device so that the virtual object is at a world-locked location as viewed by the user from a first perspective. The operations also include, in accordance with a determination, based on the user motion data, that misalignment criteria are satisfied for the virtual object, causing, at a second point in time, presentation of the virtual object by successively displaying the plurality of color fields including presenting one or more of the first color field and the second color field of the virtual object at a second display position of the head-wearable device, distinct from the first display position, so that the virtual object is at the world-locked location as viewed by the user from a second perspective.

An example of method for displaying color fields of a virtual object over time by an extended-reality system is described herein. The example method includes causing a head-wearable device to present, at a first point in time, the virtual object by successively displaying a plurality of color fields including presenting a first color field at a first display position of the head-wearable device and a second color field at the first display position of the head-wearable device so that the virtual object is at a world-locked location as viewed by the user from a first perspective. The method also includes, in accordance with a determination, based on user motion data obtained from one or more sensors, that misalignment criteria are satisfied for the virtual object, causing the head-wearable device to present, at a second point in time, the virtual object by successively displaying the plurality of color fields including presenting one or more of the first color field and the second color field of the virtual object at a second display position of the head-wearable device, distinct from the first display position, so that the virtual object is at the world-locked location as viewed by the user from a second perspective.

In another example, a non-transitory computer readable storage medium including instructions that, when executed by a computing device, cause the computing device to perform operations is disclosed. The operations include causing a head-wearable device, at a first point in time, to present a virtual object by successively displaying a plurality of color fields including presenting a first color field at a first display position of the head-wearable device and a second color field at the first display position of the head-wearable device so that the virtual object is at a world-locked location as viewed by the user from a first perspective. The operations also include, in accordance with a determination, based on user motion data obtained via one or more sensors, that misalignment criteria are satisfied for the virtual object, at a second point in time, causing the head-wearable device to present of the virtual object by successively displaying the plurality of color fields including presenting one or more of the first color field and the second color field of the virtual object at a second display position of the head-wearable device so that the virtual object is at the world-locked location as viewed by the user from a second perspective.

In yet another example, an extended-reality system for displaying color fields of a virtual object is described. The extended-reality system includes one or more processors communicatively coupled with i) a head-wearable device for presenting a virtual object to a user of the head-wearable device and ii) one or more sensors for detecting user motion data. The extended-reality system includes memory including executable instructions that, when executed by the one or more processors, cause the one or more processors to perform operations. The operations include causing, at a first point in time, presentation of the virtual object by successively displaying a plurality of color fields including presenting a first color field at a first display position of the head-wearable device and a second color field at the first display position of the head-wearable device so that the virtual object is at a world-locked location as viewed by the user from a first perspective. The operations further include, in accordance with a determination, based on the user motion data, that misalignment criteria are satisfied for the virtual object, causing, at a second point in time, presentation of the virtual object by successively displaying the plurality of color fields including presenting one or more of the first color field and the second color field of the virtual object at a second display position of the head-wearable device, distinct from the first display position, so that the virtual object is at the world-locked location as viewed by the user from a second perspective.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5A is a conceptual diagram illustrating an example artificial reality system that displays color fields.

FIG. 5B is a conceptual diagram illustrating an example display artifact from a conventional display of color fields.

FIG. 6 is an example artificial reality environment with a virtual object displayed in the presence of user movement.

FIG. 7 is a conceptual diagram illustrating determined locations at an artificial reality system display for different color fields given user movement.

FIG. 8 is a flow diagram illustrating a method used in some implementations of the present technology for displaying color fields over time by an artificial reality system.

FIG. 9 is a flow chart of a method for displaying color fields over time by an extended-reality system, in accordance with some embodiments.

FIGS. 10A, 10B, 10C-1, and 10C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems hybrid reality, or some combination and/or derivatives thereof. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments. For example, AR and MR content may include completely generated content or generated content combined with captured content (e.g., real-world photographs).

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IOT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA 100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

Aspects of the present disclosure are directed to displaying color fields over time by an artificial reality system. Some artificial reality systems display content, such as a virtual object, via successive displays of different color fields. The color fields can be rapidly displayed such that a user perceives the content in full color (i.e., the color fields for each individual color integrating into a single image). However, such systems can be susceptible to display flaws when there is user movement, such as head and/or eye movement, causing misalignment of the displayed color fields from the user's perspective. This misalignment can cause the user to perceive visual artifacts rather than a clear image of the content. Implementations of a color field manager selectively display color fields over time based on detected user movement to align the color fields from the user's perspective. For example, the display location of successively displayed color fields can be adjusted in view of detected user movement. This display location adjustment can mitigate against the display artifacts and improve clarity of the displayed content.

Some artificial reality systems display content, such as virtual objects, via a color sequential display. For example, a given virtual object can comprise three or more color fields (e.g., red, green, and blue). The artificial reality system can display the virtual object, in color, via rapidly displaying these three color fields in succession. However, user head and/or eye movement between these color field displays can cause misalignment, e.g., when the display content is meant to be viewed as staying in a consistent location relative to the physical world, as the user moves a head-mounted display (i.e., the display content is “world-locked”). Implementations of the color field manager reposition later displayed color field(s) such that they align with one or more earlier displayed color fields from the user's perspective. For example, a first color field can be displayed with respect to a first color field location at a first point in time, a second color field can be displayed with respect to a second color field location at a second point in time, and a third color field can be displayed with respect to a third color field location at a third point in time. The second and third color field locations can be determined via adjustment from the displayed first color field location and detected user movement. In some implementations, four or more color fields can be successively displayed. For example, a first color field can be displayed with respect to a first color field location at a first point in time, a second color field can be displayed with respect to a second color field location at a second point in time, a third color field can be displayed with respect to a third color field location at a third point in time, and a fourth color field can be displayed with respect to a fourth color field location at a fourth point in time. The second, third, and fourth color field locations can be determined via adjustment from the displayed first color field location and detected user movement.

In some implementations, the artificial reality system immerses a user in a virtual environment comprising real-world elements, such as a mixed reality or augmented reality environment. In order for virtual content to appear spatially consistent with the real world (e.g., world-locked) the virtual content can be repositioned according to the user's eye tracking and/or head pose. Implementations reposition color fields with up-to-date user positioning (e.g., head pose and/or eye tracking) before each color field is displayed. In some implementations, 6 degrees of freedom reprojection can compensate for rotational as well as translational head motion, for example to align color fields on the retina of the user when their eyes are exhibiting vestibulo-ocular reflex (VOR) motion.

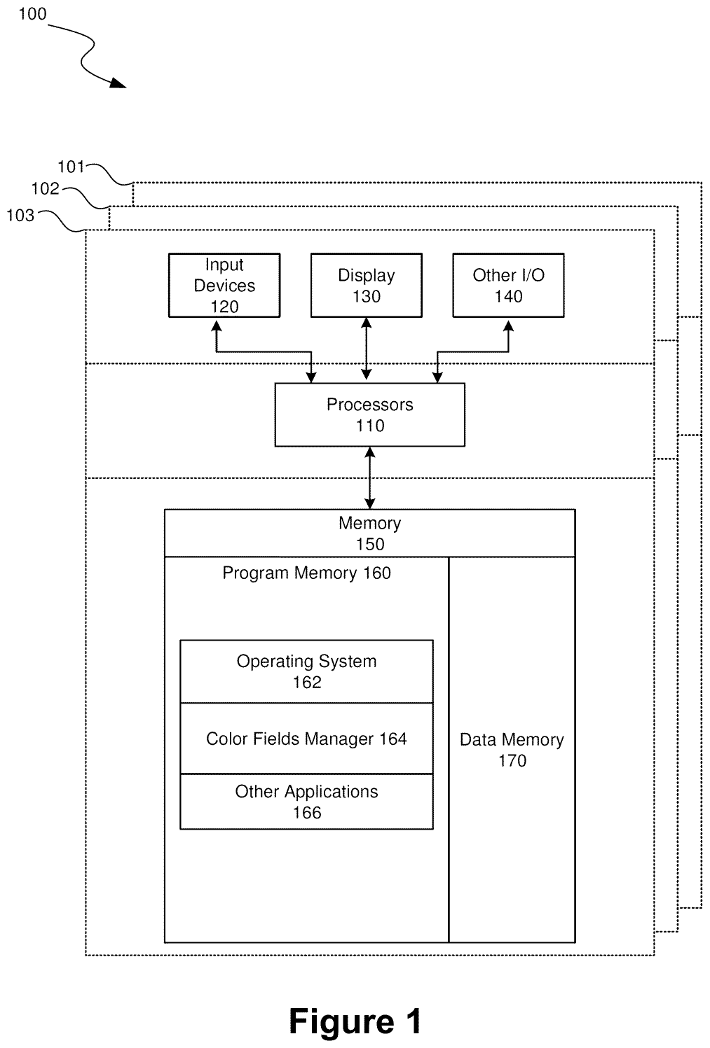

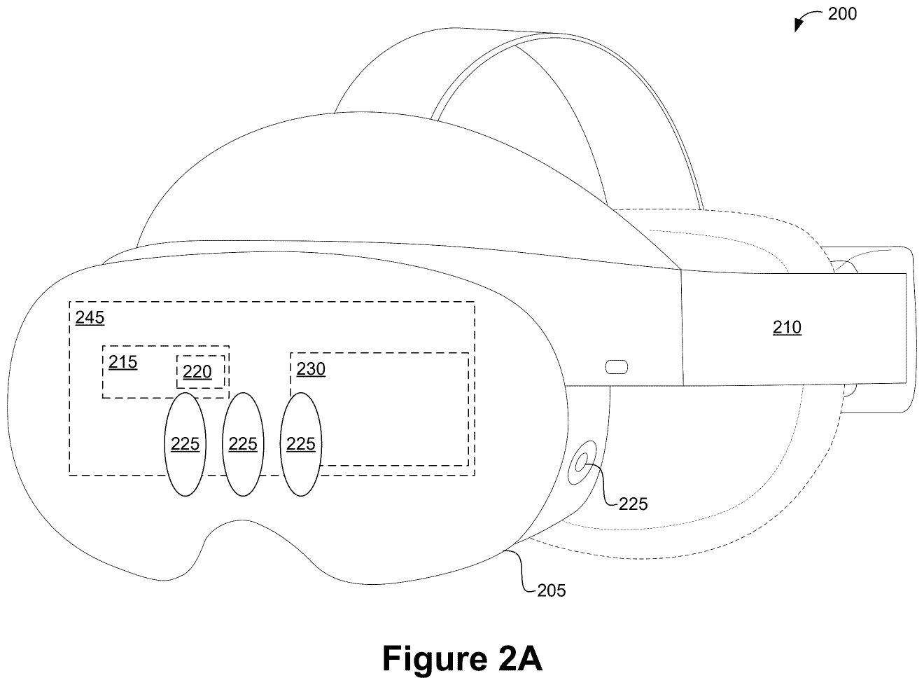

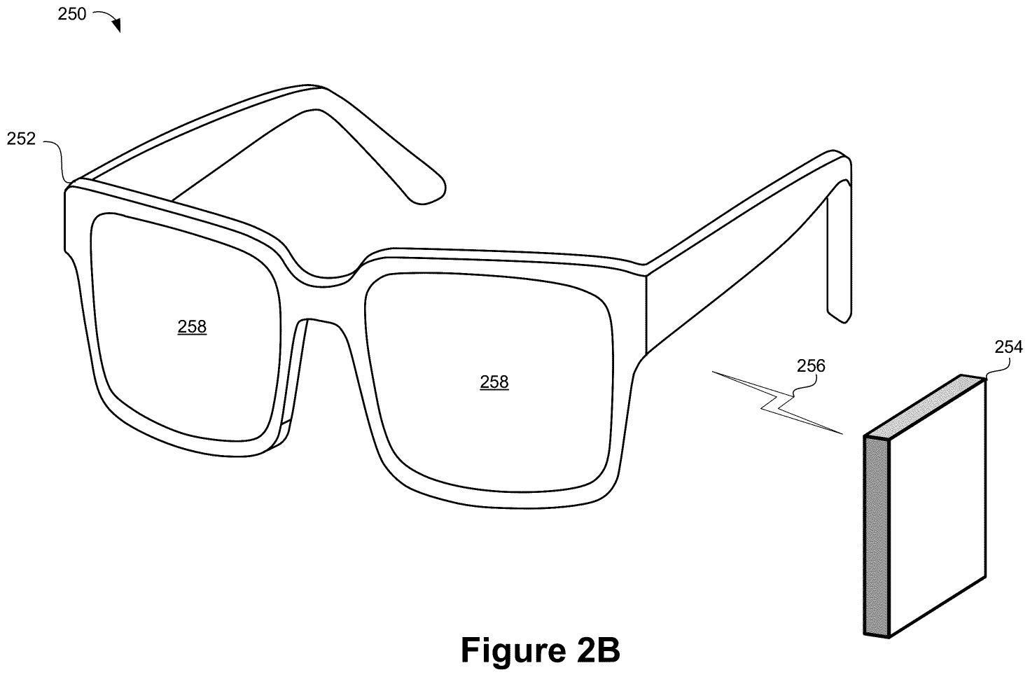

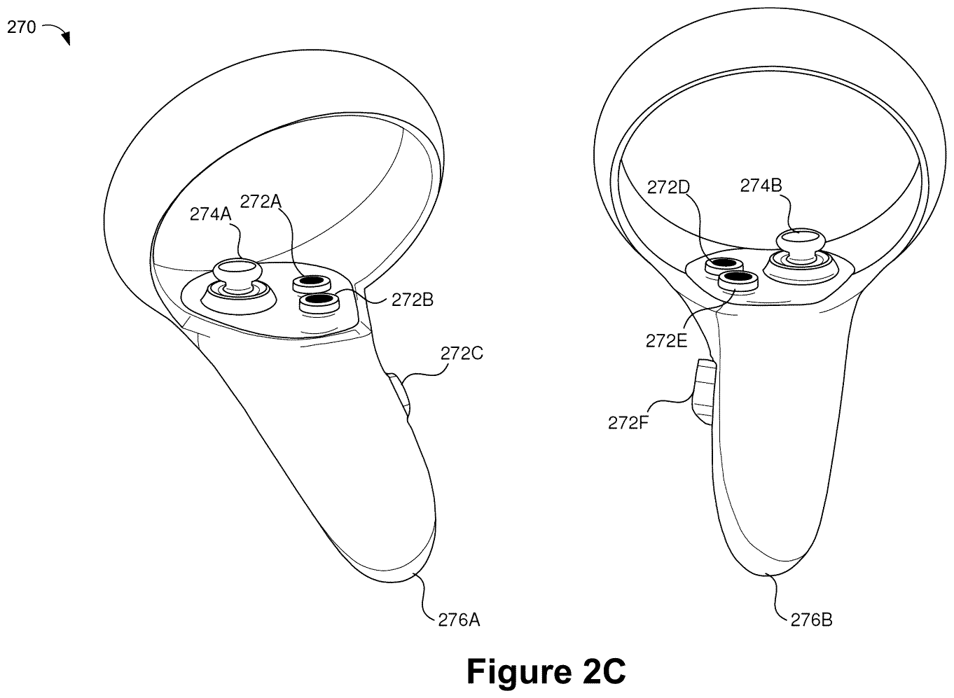

Several implementations are discussed below in more detail in reference to the figures. FIG. 1 is a block diagram illustrating an overview of devices on which some implementations of the disclosed technology can operate. The devices can comprise hardware components of a computing system 100 that display color fields over time. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., CPUs, GPUs, holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This SLAM system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of RAM, various caches, CPU registers, ROM, and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, color fields manager 164, and other application programs 166. Memory 150 can also include data memory 170 that can include, e.g., configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

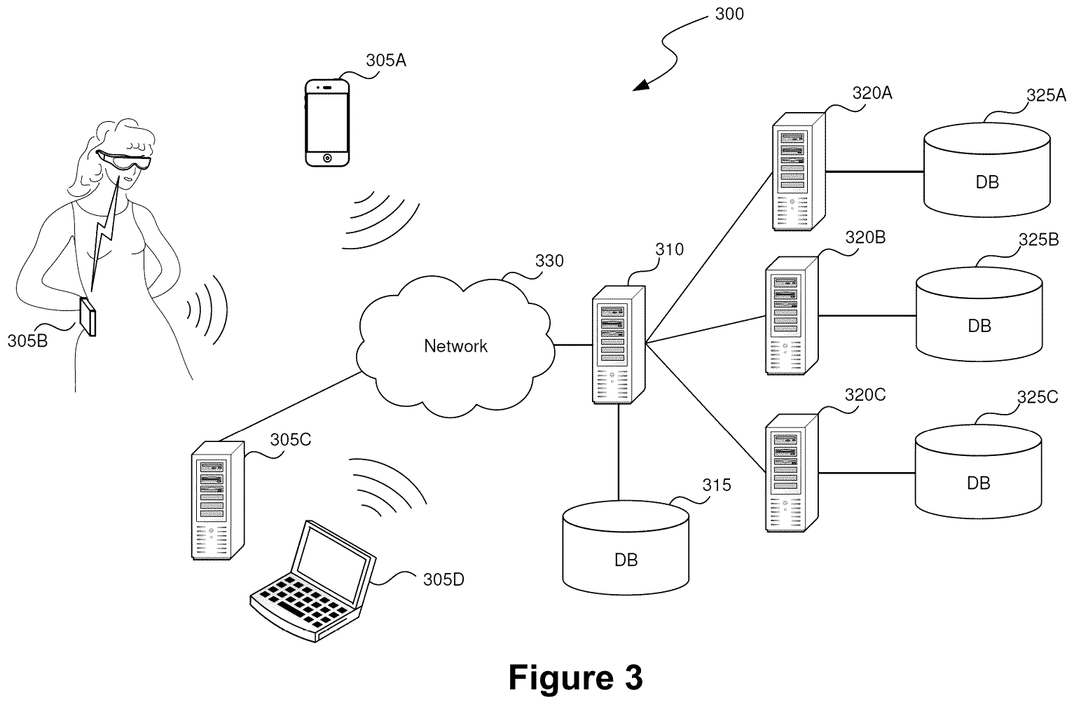

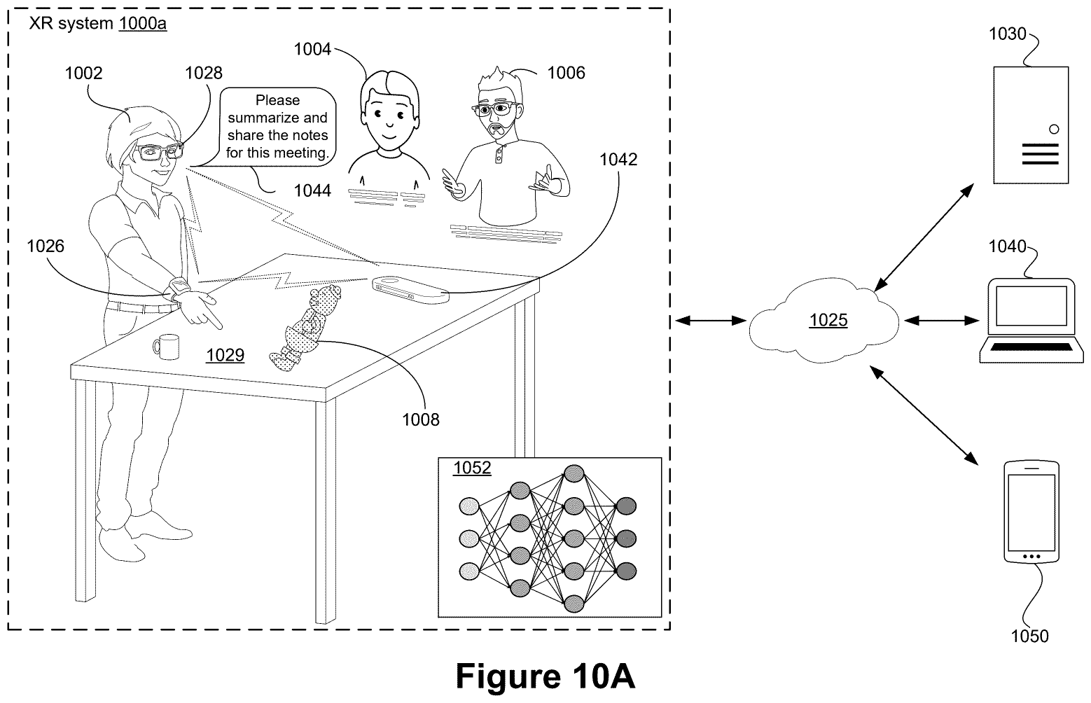

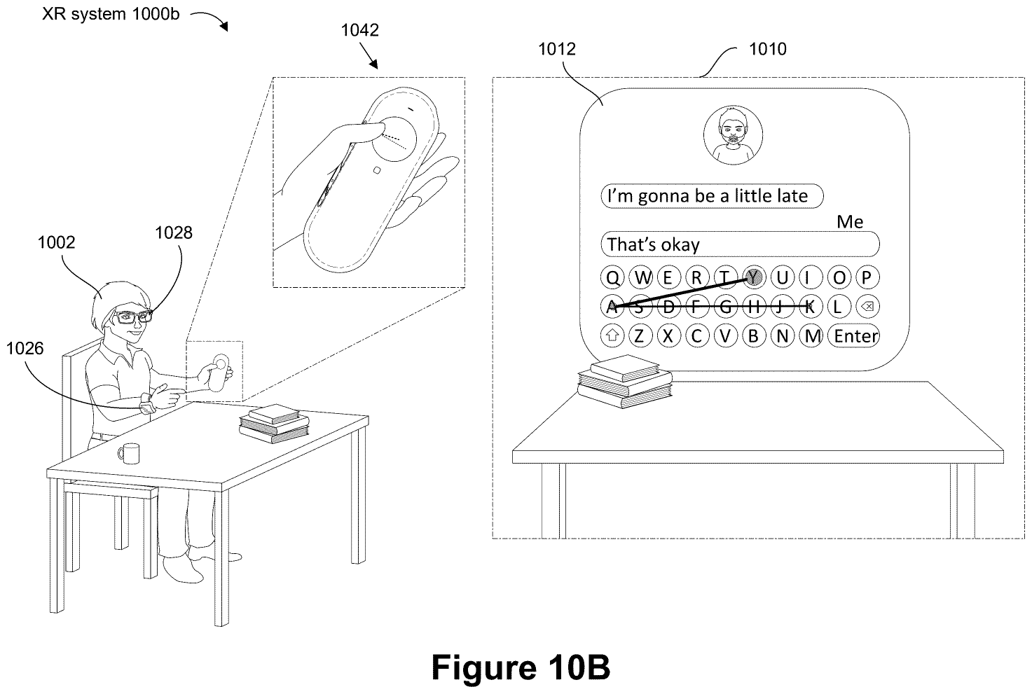

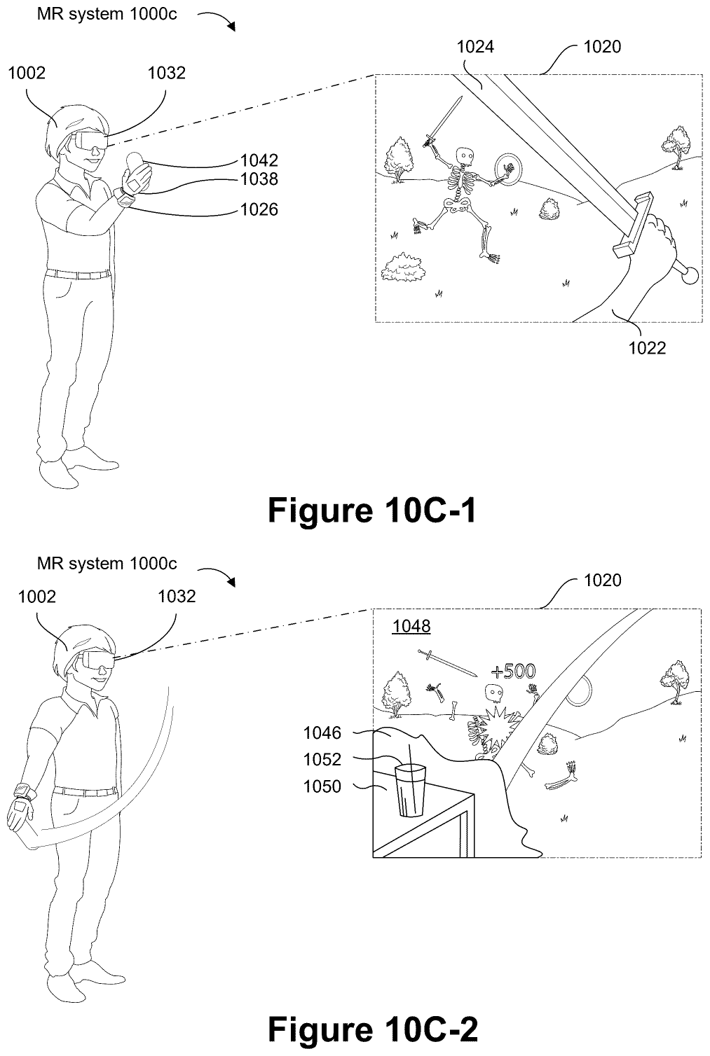

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250 (or any other XR system described below in reference to FIGS. 10A-10C-2). Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

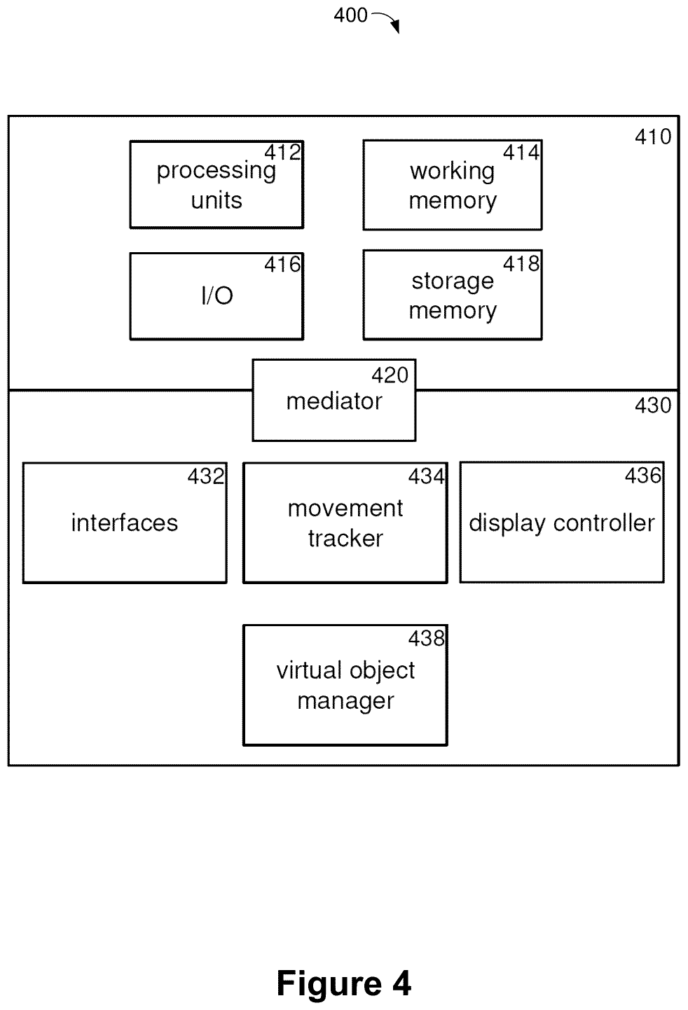

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for displaying color fields over time. Specialized components 430 can include movement detector 434, display controller 436, virtual object manager 438, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

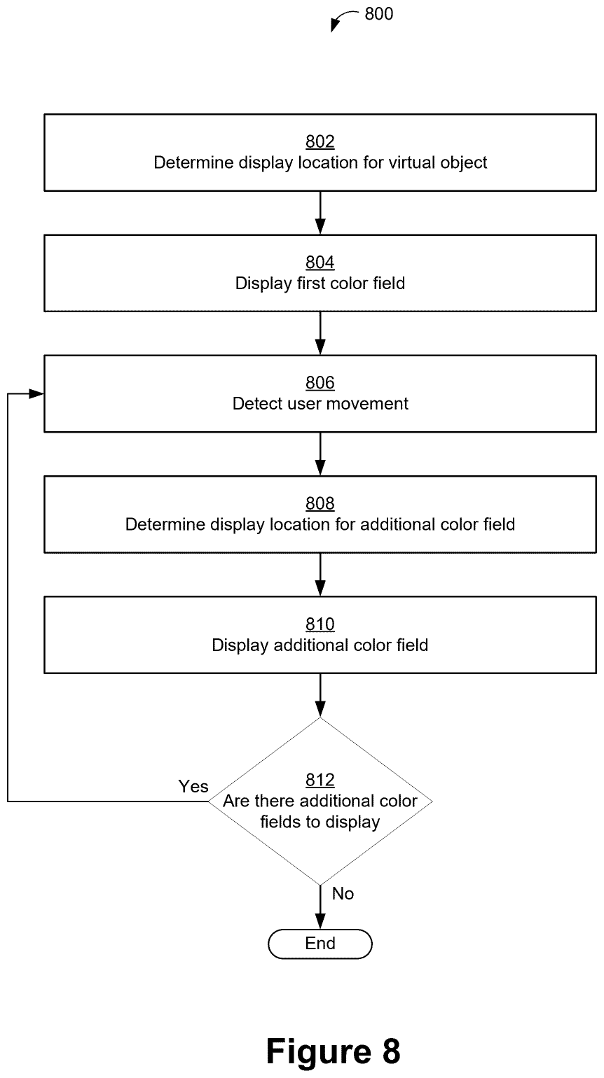

Movement tracker 434 can track user movement over time, such as head movement and/or eye movement. For example, sensors can detect XR system and/or user movement, such as inertial measurement units (IMUs), accelerometers, gyroscopes, proximity detectors, infrared detectors, camera(s), and the like. In some implementations, one or more of these sensors can be located at an HMD of an XR system worn by a user. Movement tracker can detect, based on sensor signals, user head movement, user eye movement, or a combination of these (e.g., using the technologies described above or others known to those skilled in these art areas). At times the system can simultaneously track user head movement and eye movement. In some implementations, the XR system can display an XR environment, such as an MR or AR environment, to a user, and the tracked user movement is indicative of a change in the user's perspective of the XR environment. Display controller 436 can receive tracked user movement from movement tracker 434 and control the XR system display in response to the user movement. Additional details on movement tracker 434 are provided below in relation to block 806 of FIG. 8.

Display controller 436 can control, at least in part, a display of an XR system, for example to display an XR environment and/or virtual object(s) to a user. In some implementations, display controller 436 rapidly displays different color fields of a virtual object over time such that the user perceives the virtual object in full color. For example, display controller 438 can determine a display location for color fields of the virtual object with respect to a display of an XR system. The display location can be determined such that the virtual object is located at a position in an XR environment (e.g., AR environment, MR environment, etc.) relative to the user's perspective of that environment. In some implementations, display controller 436 can receive, from movement tracker 434, user movement information and determine one or more different display locations for different color fields of a virtual object. For example, user movement may alter the user's perspective of the XR environment, and thus display controller 436 may alter a display location between successive color fields such that that the successively displayed color fields align from the user's perspective. Additional details on display controller 436 are provided below in relation to blocks 802, 804, 808, and 810 of FIG. 8.

Virtual object manager 438 can manage virtual objects for display to a user. For example, virtual object manager 438 can access display information for the virtual objects, such as structural information (e.g., three-dimensional mesh, etc.) and/or texture information (e.g., virtual object skins, etc.). In some implementations, virtual object manager 438 can manage the display location for a virtual object within an XR environment. For example, in an AR or MR environment a given virtual object can be world-locked with respect to a real-world object (or another displayed virtual object). Virtual object manager 438 can determine and/or store location data, such as anchor point(s), for the virtual object's display location. Virtual object manager 438 can provide a virtual object's display information and/or location data to display controller 436 for display of the virtual object via an XR system display. Additional details on virtual object manager 436 are provided below in relation to blocks 802, 804, 808, and 810 of FIG. 8.

Implementations of an XR system, such as system 200 or 250, display, to a user, virtual object(s) in an AR or MR environment, such as an environment that includes real-world elements and virtual elements. For example, a virtual object (e.g., two-dimensional object, three-dimensional object, etc.) can be displayed within the real-world surroundings of the user and/or XR system. The XR system can accomplish this display of the virtual object via rapidly displaying different color fields for the virtual object. For example, multiple color fields (e.g., red, green, and blue) can be rapidly displayed by the XR system over time. The rapidly displayed color fields can be perceived by the user, via the user's eye(s) and visual processing, as a multi-color virtual object.

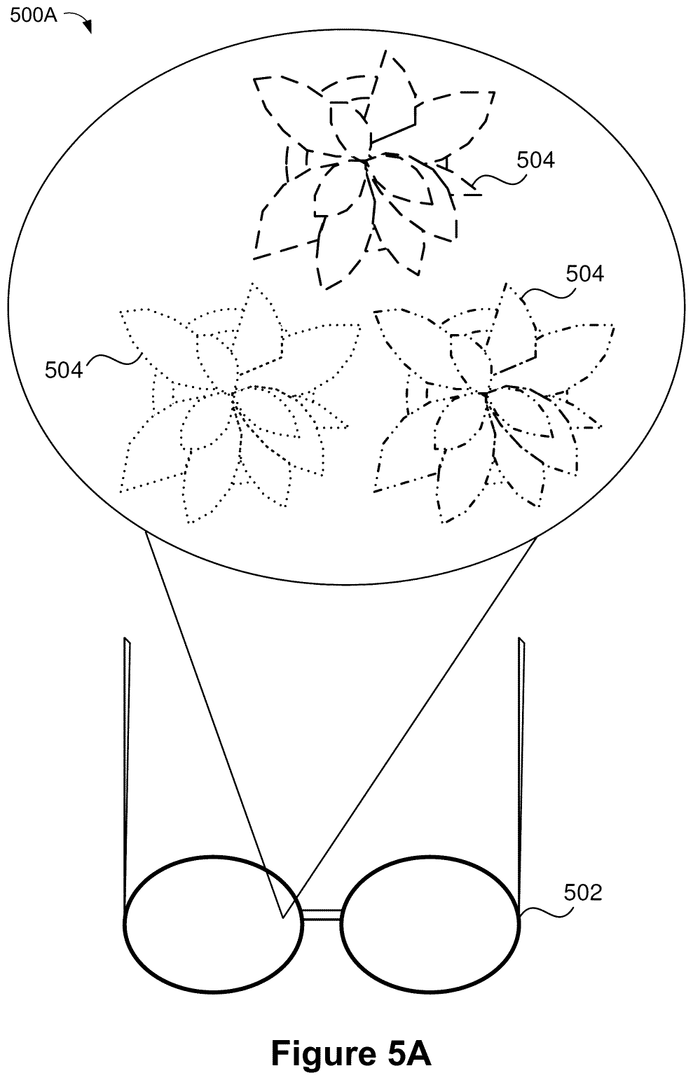

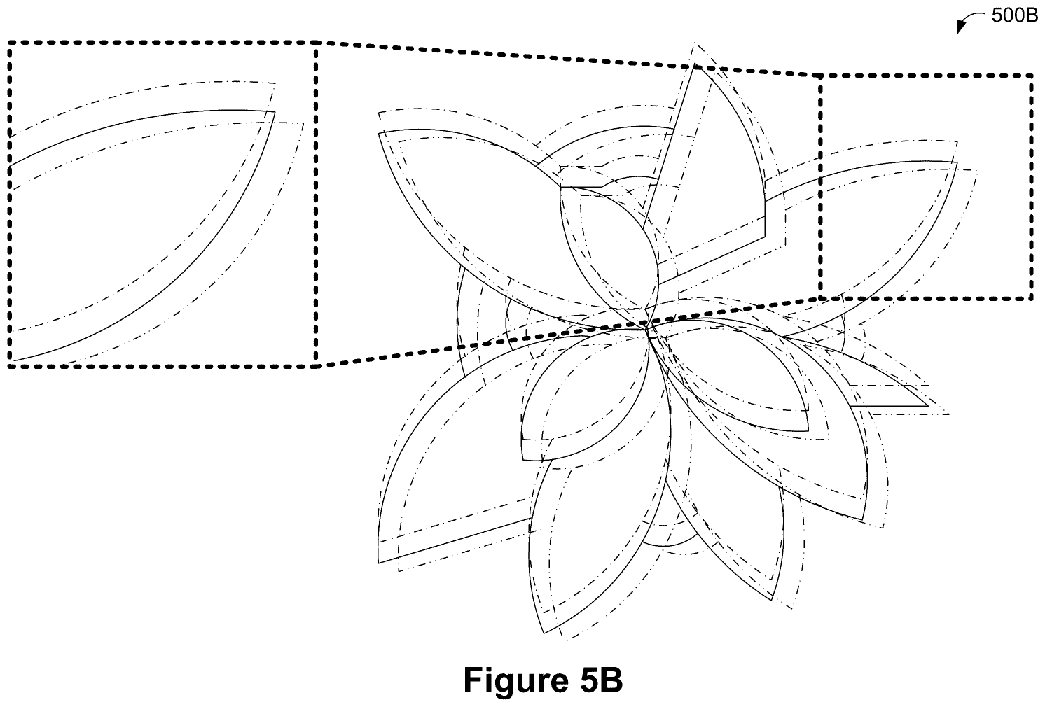

FIG. 5A is a conceptual diagram illustrating an example artificial reality system that displays color fields. Diagram 500A illustrates XR system 502 and color fields 504. XR system 502 can be augmented reality and/or mixed reality glasses, an HMD, systems 200 or 250, or any other suitable XR system comprising display device(s). In some implementations, XR system 502 renders computer generated content (e.g., virtual objects) via successive displays of color fields 504, such as via a liquid crystal on silicon (LCoS) display system. Each of color fields 504 can correspond to a different color spectrum (e.g., light wavelength(s)), such as red, green, and blue color fields. While FIG. 5A shows color fields 504 as being at different locations for clarity in this application, they are displayed so the user sees them at the same location, integrating the color fields, to the user, into a single image. A user of XR system 502 perceives the successive displays of color fields 504 as a color virtual object (e.g., full color virtual object comprising all of the red, green, and blue color fields). For example, XR system 502 can comprise a refresh rate, and each refresh can include one or more displays of each of color fields 502.

However, XR systems that rely on color fields for the display of computer generated content can encounter display artifacts in the presence of user movement. FIG. 5B is a conceptual diagram illustrating an example display artifact from a conventional display of color fields. Diagram 500B illustrates color fields displayed over time that cause display artifact(s), for example based on user movement. User movement between successive displays may cause misalignment of color fields in conventional XR systems. The virtual flower illustrated in diagram 500B includes blurring of both color and clarity due to this misalignment. Accordingly, over a period of time (e.g., refresh instance according to a given refresh rate), user movement, such as head movement and/or eye(s) movement, can change the user's perspective of the XR environment displayed via a conventional XR system (e.g., lenses of the HMD) in a manner that misaligns successively displayed color fields.

Implementations determine display locations for successively displayed color fields in the presence of user movement. For example, user movement can be detected after a first color field is displayed at a given display location, and display location(s) for second and/or third color field(s) can be determined based on the user movement so that, from the user's perspective, the displayed second and/or third color fields align with the displayed first color field. In other examples, user movement can be detected after a first color field is displayed at a given display location, and display location(s) for second, third, and fourth color fields can be determined based on the user movement so that, from the user's perspective, the displayed second, third, and fourth color fields align with the displayed first color field. Any suitable number of color fields (e.g., two, three, four, five, or more) can be implemented. In some implementations, color field display location(s) are aligned over a given refresh instance to maintain clarity for the user.

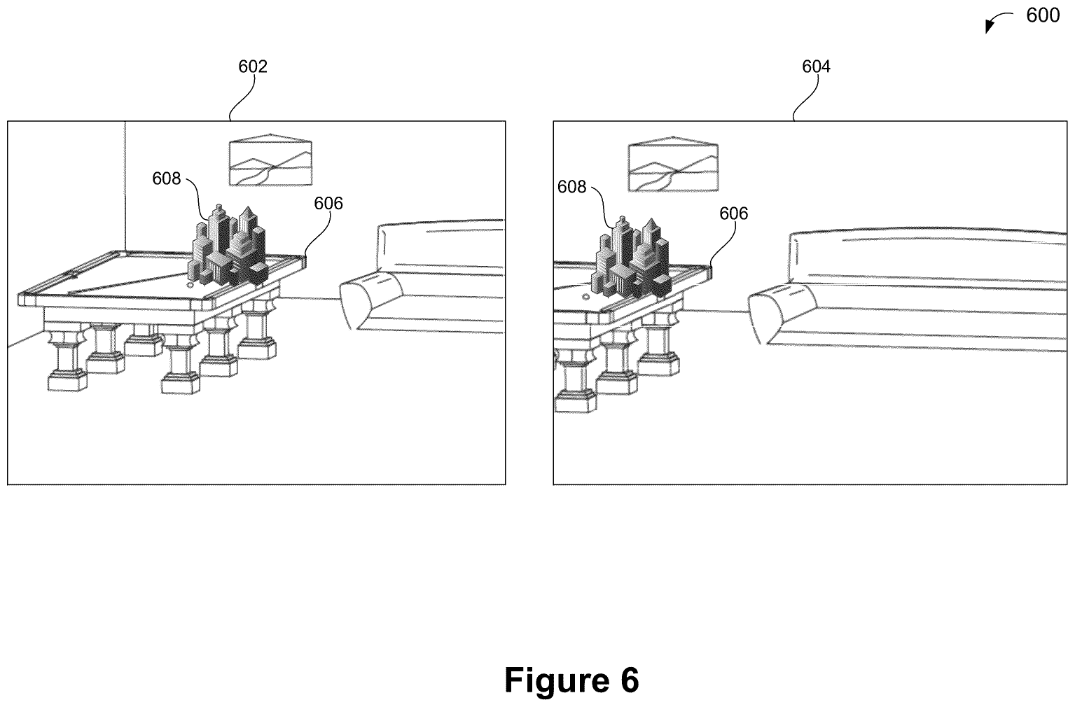

FIG. 6 is an example artificial reality environment with a virtual object displayed in the presence of user movement. Diagram 600 illustrates XR environment 602, XR environment 604, real-world object 606, and virtual object 608. XR environments 602 and 604 comprise an AR or MR environment, displayed to a user via an XR system, that includes real-world object 606 and virtual object 608. In the illustrated example, virtual object 608 can be anchored to real-world object 606. XR environment 602 can correspond to a first point in time and XR environment 604 can correspond to a second point in time, where user movement change's the user's perspective of the XR environment between these two points of time. For example, user eye movement and/or user head movement can alter the user's perspective, as illustrated in FIG. 6.

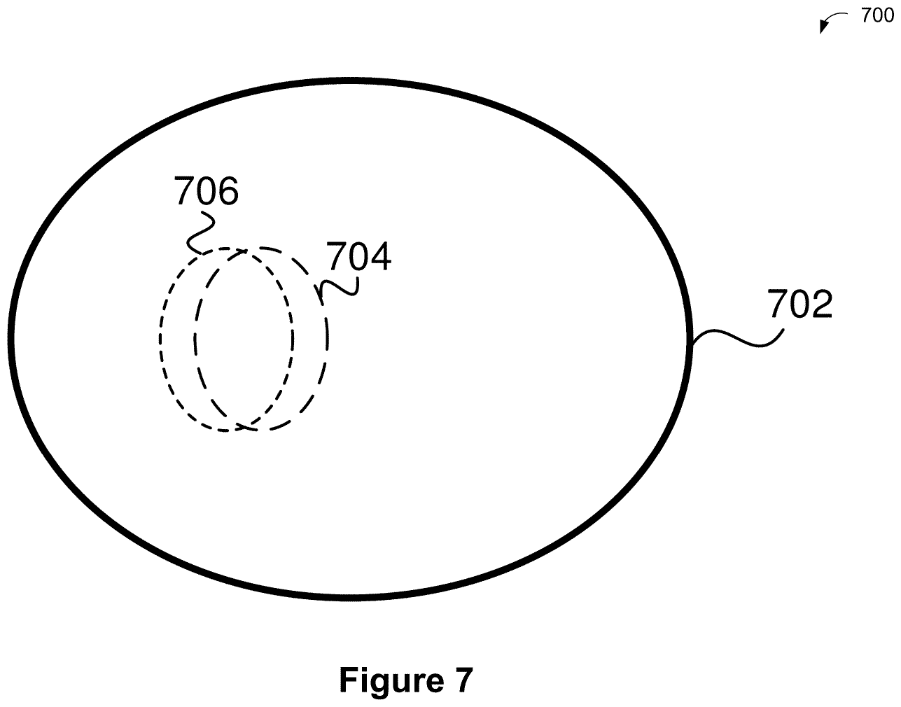

Implementations of a color field manager display a first color field relative to the first point in time (corresponding to the perspective from XR environment 602) and a second color field relative to the second point in time (corresponding to the perspective from XR environment 602), however because of the change in the user's perspective the display locations of the color fields are different. The color field manager can determine a display location for the first color field such that virtual object 608 appears, from the user's perspective at the first point in time, to be anchored to specific point(s) of real-world object 606. Similarly, the color field manager can determine an updated display location for the second color field such that virtual object 608 appears, from the user's perspective at the second point in time, to be anchored to the same specific point(s) of real-world object 606. Diagram 700 of FIG. 7 further illustrates the determined display locations for virtual object 608 at the different points in time.

FIG. 7 is a conceptual diagram illustrating determined locations at an artificial reality system display for different color fields given user movement. Diagram 700 illustrates XR system display 702, color field display location 704, and color field display location 706. With respect to the example illustrated by XR environment 602, XR environment 604, real-world object 606, and virtual object 608 of FIG. 6, color field display location 704 corresponds to XR environment 602 at the first point in time, and color field display location 706 corresponds to XR environment 604 at the second point in time. For example, the color field manager can determine color field display location 704 based on the user's context (e.g., eye tracking and/or head tracking) and display parameters for virtual object 608 (e.g., anchor(s) with respect to real-world object 606). The color field manager can determine an adjustment for color field display location 706 based on detected user movement (e.g., eye(s) and/or head movement). For example, color field display location 706 can be determined such that the displayed color fields of virtual object 608 are aligned from the user's perspective.

In some implementations, color field display location 706 can be determined using a) color field display location 704, and b) one or more adjustment metric(s) calculated based on the detected user movement between the first point and time and the second point in time. For example, the color field manager can translate tracked user movement into positional adjustments for the color field display location 706. In some implementations the color field manager adjustments compensate for 6 degrees of freedom (6Dof) movement and/or 3 degrees of freedom (3Dof) movement. For example, color field manager can determine an amount of eye movement which can be from tracked head movement, tracked eye movement, or a combination where a first vector of eye movement is combined with a second vector of head movement to get an overall eye movement. In some cases, this tracked eye movement can also include rotational movement. The color field manager can translate this movement into an update to the virtual object position by applying position/rotation changes to the virtual object corresponding to the eye movement changes in the X and Y axes and rotation, and can apply scaling changes to the virtual object according to changes in the Z axis. In some implementations, the color field location adjustments for some movement (e.g., 6Dof compensation) is based on the depth of virtual content. For example, adjusting color field(s) for a three-dimensional virtual object can be based on depth information with respect to a displayed XR environment. Any other suitable technique can be used to determine color field display location 706 such that the displayed color fields of virtual object 606 are aligned from the user's perspective.

In some implementations, virtual object 608 can comprise three or more color fields. For example, a first color field can be displayed with respect to a first color field location at a first point in time, a second color field can be displayed with respect to a second color field location at a second point in time, and a third color field can be displayed with respect to a third color field location at a third point in time. The second and third color field locations can be determined via adjustment from the displayed first color field location and detected user movement. For example, the second color field location can be determined based on the displayed first color field location and detected user movement between the first point in time and the second point in time, and the third color field location can be determined based on: the displayed first color field location and detected user movement between the first point in time and the third point in time; the displayed second color field location and detected user movement between the second point in time and the third point in time; or any combination thereof.

In another example, a first color field can be displayed with respect to a first color field location at a first point in time, a second color field can be displayed with respect to a second color field location at a second point in time, a third color field can be displayed with respect to a third color field location at a third point in time, and a fourth color field can be displayed with respect to a fourth color field location at a fourth point in time. The second, third, and fourth color field locations can be determined via adjustment from the displayed first color field location and detected user movement. For example, the fourth color field location can be determined based on: the displayed first color field location and detected user movement between the first point in time and the fourth point in time; the displayed second color field location and detected user movement between the second point in time and the fourth point in time; the displayed third color field location and detected user movement between the third point in time and the fourth point in time; or any combination thereof. Any suitable number of color fields (e.g., two, three, four, or more) can be implemented.

In some implementations, the different color field display locations can compensate for vestibulo-ocular reflex (VOR) motion, or the counter rotation of a user's eye(s) in the presence of user head movement. For example, the counter rotation of the user's eye(s) in the presence of head movement can commonly cause misalignment of displayed color fields in a color sequential display system absent location adjustment. Implementations of the color field manager can compensate for this misalignment via altering the display location(s) of successively displayed color field(s).

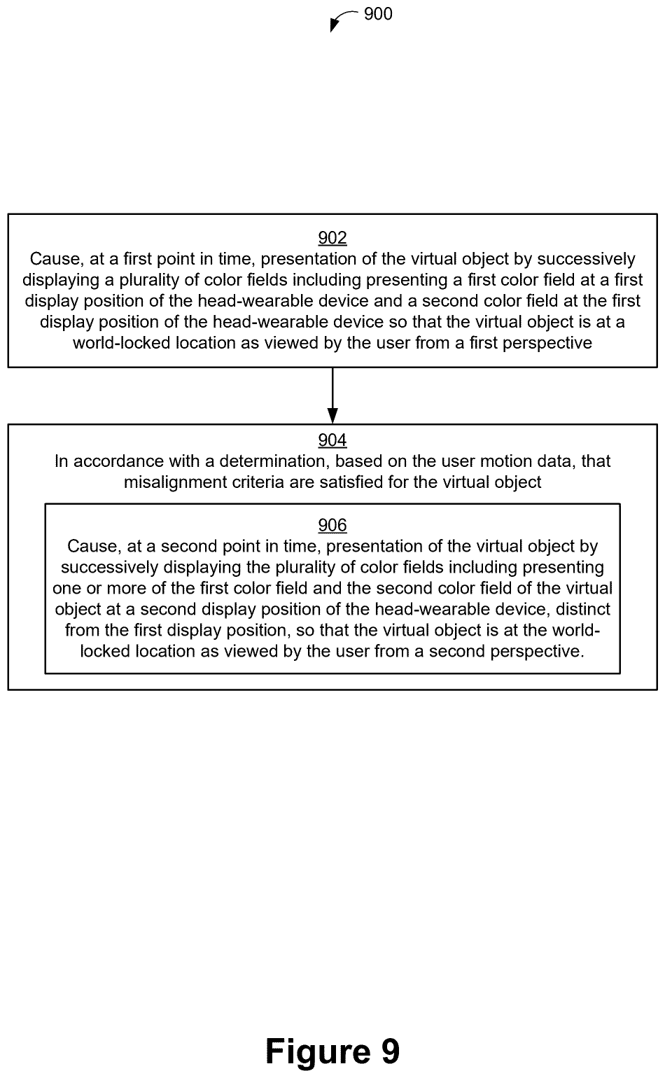

FIGS. 8 and 9 illustrates flow diagrams of methods of presenting successive color fields for displaying a virtual object, in accordance with some embodiments. Operations (e.g., steps) of the methods 800 and 800 can be performed by one or more processors (e.g., central processing unit and/or MCU) of a system (e.g., HMD system 200 (FIG. 2A), HMD system 250 (FIG. 2B), and/or any XR system descried below in reference to FIGS. 10A-10C-2). At least some of the operations shown in FIGS. 8 and 9 correspond to instructions stored in a computer memory or computer-readable storage medium (e.g., storage, RAM, and/or memory). Operations of the methods 800 and 900 can be performed by a single device alone or in conjunction with one or more processors and/or hardware components of another communicatively coupled device (e.g., a wrist-wearable device 1026, a handheld intermediary processing device 1042, a server 1030, a computer 1040, a mobile device 1050, and/or other electronic devices described below in reference to FIGS. 10A-10C-2) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems.

Those skilled in the art will appreciate that the components illustrated in FIGS. 1-7 described above, and in the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes or method operations described below. For convenience, the method operations will be described below as being performed by particular component or device, but should not be construed as limiting the performance of the operation to the particular device in all embodiments.

FIG. 8 is a flow diagram illustrating a method used in some implementations of the present technology for displaying color fields over time by an artificial reality system. Method 800 can be performed by a head-wearable device (e.g., HMD 200 (FIG. 2A), HMD 250 (FIG. 2B), AR device 1028 (FIGS. 10A and 10B), MR device 1032 (FIG. 10C-1 and 10C-2), an XR system, and/or any other suitable computing device(s). Method 800 can be triggered by a display of a virtual object, upon activation of an XR system and/or an operating mode of the XR system, or via any other suitable trigger.

At block 802, method 800 determines a display location for a virtual object. For example, a virtual object can comprise a location in the context of an XR environment, such as an AR or MR environment. The virtual object location can be based on a three-dimensional point/position, a world-locked position, anchor points (e.g., with respect to a real-world and/or virtual object), and the like. In some cases, the location can be a location of a world-locked virtual object based on a predicted amount of movement by a user—e.g., a machine learning model can be trained to predict, for an amount of time taken by a rendering process, where a user's head and/or eyes will be, given their current location, amount of movement, expected changes in the display, etc. For example, the machine learning model can be based on previously observed user movement (for a specific XR system user or for XR system users generally) given these factors.

At block 804, method 800 displays a first color field of the virtual object. The virtual object can comprise multiple color fields (e.g., two, three, or more) that, when rapidly displayed in succession, are perceived by a user as the virtual object in color. The XR system can display, via an HMD and within an XR environment, the first color field at the determined location for the virtual object.

At block 806, method 800 detects user movement. For example, detected user movement can be head movement or eye(s) movement (e.g., in 6DoF or 3DoF). In some implementations, the detected user movement alters the user's perspective of the XR environment displayed via the XR system.

At block 808, method 800 determines a display location for additional color field. For example, a second color field location can be determined based on the displayed first color field location and the detected user movement. The determined location for the second color field can compensate for the detected user movement such that the display locations for the first and second color fields align from the user's perspective. For example, one or more positional adjustments can be calculated, based on the detected user movement, and applied to the display location of the first color field to determine the display location for the second color field.

At block 810, method 800 can display the additional color field at the determined display location. For example, the second color field can be displayed at the second location. At block 812, method 800 determines whether there are additional color fields to display. At block 812, method 800, in accordance with a determination that there are additional color fields to display (“Yes” at block 812), can loop back to block 806 when there are additional color fields for display. For example, displaying the virtual object can include displaying three distinct color fields. Block 806-810 can be iterated over for the third color field such that A) a displayed location is determined for the third color field based on detected user movement, and B) the third color field is displayed at the determined display location.

In some examples, displaying the virtual object can include displaying four color fields. Block 806-810 can be iterated over for the fourth color field such that A) a displayed location is determined for the fourth color field based on detected user movement, and B) the fourth color field is displayed at the determined display location. In some implementations, display of a virtual object can including successively displaying two, three, four, or more color fields.

Returning to block 812, method 800, in accordance with a determination that there are no additional color fields to display (“No” at block 812), can terminate when there are no additional color fields for display.

In some implementations, the virtual object can be displayed to the user via successive displaying of the first color field, the second color field, and the third color field. For example, the first color field, the second color field, and the third color field can correspond to different visible color spectrum (e.g., red, green, and blue color channels). In some implementations, the displayed color field make the virtual object appear world-locked to the user within the XR environment in the presence of the user movement.

In some implementations, the virtual object can be displayed to the user via successive displaying of the first color field, the second color field, the third color field, and a fourth color field. Any suitable number of color fields (e.g., two, three, four, or more) can be implemented.

(A1) FIG. 9 shows a flow chart of a method 900 for displaying color fields over time by an extended-reality system, in accordance with some embodiments. The method 900 occurs at a head-wearable device (e.g., HMD 200 (FIG. 2A), HMD 250 (FIG. 2B), AR device 1028 (FIGS. 10A and 10B), MR device 1032 (FIG. 10C-1 and 10C-2)) with one or more imaging devices, displays (or display assemblies, such as waveguides and projectors), sensors (e.g., IMUs, eye-track systems or sensors, and/or other sensors to track user movement). In some embodiments, the method 900 includes causing (902) the head-wearable device to present, at a first point in time, a virtual object by successively displaying a plurality of color fields including presenting a first color field at a first display position of the head-wearable device and a second color field at the first display position of the head-wearable device so that the virtual object is at a world-locked location as viewed by the user from a first perspective. For example, as described above in reference to FIGS. 6 and 7, one or more color fields of a virtual object can be presented at a first location at a first point in time.

The method 900 also includes, in accordance with a determination (904), based on the user motion data, that misalignment criteria are satisfied for the virtual object, causing (906) the head-wearable device to present, at a second point in time, the virtual object by successively displaying the plurality of color fields including presenting one or more of the first color field and the second color field of the virtual object at a second display position of the head-wearable device, distinct from the first display position, so that the virtual object is at the world-locked location as viewed by the user from a second perspective. For example, as described above in reference to FIGS. 6 and 7, the one or more color fields of the virtual object can be presented at a second location at a second point in time based on a change in the user's perspective. The change in the user's perspective can be caused by a change in the user's head pose and/or position, a user's eye movements, and/or movement by the user.

(A2) In some embodiments of A1, the plurality of color fields includes a third color field. Causing the head-wearable device to present, at the first point in time, the virtual object by successively displaying the plurality of color fields includes presenting i) the first color field at the first display position of the head-wearable device, ii) the second color field at the first display position of the head-wearable device, and iii) the third color field at the first display position of the head-wearable device so that the virtual object is at the world-locked location as viewed by the user from the first perspective. Causing the head-wearable device to present, at the second point in time, the virtual object by successively displaying the plurality of color fields includes presenting one or more of the first color field, the second color field, and the third color filed at the second display position of the head-wearable device so that the virtual object is at the world-locked location as viewed by the user from a second perspective. As described above in reference to FIGS. 5A-7, a virtual object can include a plurality of color fields. In some embodiments, the virtual object includes two or more color fields, three or more color fields, four or more color fields, etc.

(A3) In some embodiments of A2, the plurality of color fields includes a fourth color field. Causing the head-wearable device to present, at the first point in time, the virtual object by successively displaying the plurality of color fields includes presenting i) the first color field at the first display position of the head-wearable device, ii) the second color field at the first display position of the head-wearable device, iii) the third color field at the first display position of the head-wearable device, and iv) the fourth color field at the first display position of the head-wearable device so that the virtual object is at the world-locked location as viewed by the user from the first perspective. Causing the head-wearable device to present, at the second point in time, the virtual object by successively displaying the plurality of color fields includes presenting one or more of the first color field, the second color field, the third color field, and the fourth color field at the second display position of the head-wearable device so that the virtual object is at the world-locked location as viewed by the user from a second perspective.

(A4) In some embodiments of any of A1-A3, the method 900 further includes, in accordance with a determination, based on additional user motion data, that misalignment criteria are satisfied for the virtual object, causing the head-wearable device to present, at a third point in time, the virtual object by successively displaying the plurality of color fields including presenting one or more of the first color field and the second color field of the virtual object at a third display position of the head-wearable device so that the virtual object is at the world-locked location as viewed by the user from a third perspective. As described above in reference to FIGS. 6 and 7, a display location of one or more color fields can be changed over time based on detected user movement to align the color fields from the user's perspective.

(A5) In some embodiments of any of A1-A4, each color field of the plurality of color fields is a distinct visible colors.

(A6) In some embodiments of any of A1-A5, the method 900 also includes determining the second display position of the head-wearable device based on, at least, the first display position of the head-wearable device and the user motion data.

(A7) In some embodiments of any of A1-A6, the user motion data includes one or more of a head movement, an eye movement, and user movement.

(A8) In some embodiments of any of A1-A7, the misalignment criteria includes one or more of an eye movement above a predetermined eye-movement threshold, a head movement above a predetermined head-movement threshold, and a combination thereof.

(A9) In some embodiments of any of A1-A8, the first display position of the head-wearable device and the second display position of the head-wearable device align the virtual object as viewed by the user from a second perspective.

(A10) In some embodiments of any of A1-A9, the virtual object is presented as part of an XR environment including one of an augmented-reality environment or mixed-reality environment that includes a visual of the user's real-world surroundings.

(A11) In some embodiments of any of A1-A10, the head-wearable device is augmented-reality glasses or mixed-reality glasses.

(B1) In accordance with some embodiments, a method for displaying color fields over time by an artificial reality (XR) system is disclosed. The method includes displaying, at a first time by the XR system to a user, a first color field of a virtual object at a first location with respect to a display of the XR system. The displayed first color field at the first location corresponds to a first position in an XR environment relative to the user's perspective. The method also includes detecting, by the XR system, user movement and displaying, at a second time by the XR system, a second color field of the virtual object at a second location with respect to the display of the XR system. The detected user movement alters the user's perspective of the XR environment. The second location, at which the second color field is displayed, corresponds to the first position in the XR environment and is relative to the user's perspective as altered by the user movement.

(B2) In some embodiments of B1, the displaying of the first color field and the second color field is part of displaying, to the user, the virtual object.

(B3) In some embodiments of any of B1-B2, the method further includes determining the second location with respect to the display of the XR system at least based on the user movement.

(B4) In some embodiments of any of B1-B3, the user movement includes user head movement and/or user eye movement.

(B5) In some embodiments of any of B1-B4, method includes displaying, at a third time by the XR system, a third color field of the virtual object at a third location with respect to the display of the XR system. The virtual object is displayed to the user via successive displaying of the first color field, the second color field, and the third color field.

(B6) In some embodiments of B5, the first color field, the second color field, and the third color field correspond to different visible colors.

(B7) In some embodiments of any of B5-B6, the method further includes displaying, at a fourth time by the XR system, a fourth color field of the virtual object at a fourth location with respect to the display of the XR system. The virtual object is displayed to the user via successive displaying of the first color field, the second color field, the third color field, and the fourth color field.

(B8) In some embodiments of any of B1-B7, the XR environment includes an augmented reality or mixed reality environment that includes a visual of the user's real-world surroundings.

(B9) In some embodiments of any of B1-B8, the virtual object appears world-locked to the user within the XR environment in the presence of the user movement.

(B10) In some embodiments of any of B1-B9, the XR system comprises augmented reality or mixed reality glasses.

(C1) In accordance with some embodiments, a system that includes a wrist wearable device (or a plurality of wrist-wearable devices) and a pair of augmented-reality glasses, and the system is configured to perform operations corresponding to any of A1-B10.

(D1) In accordance with some embodiments, a non-transitory computer readable storage medium including instructions that, when executed by a computing device in communication with a pair of augmented-reality glasses, cause the computer device to perform operations corresponding to any of A1-B10.

(E1) In accordance with some embodiments, a method of operating a pair of augmented-reality glasses, including operations that correspond to any of A1-B10.

(F1) In accordance with some embodiments, a means for causing performance of operations that correspond to any of A1-B10.

(G1) In accordance with some embodiments, a head-wearable device including a display, one or more sensors, one or more processors, and memory including instructions, that when executed by the one or more processors causer performance of operations that correspond to any of A1-B10.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

FIGS. 10A 10B, 10C-1, and 10C-2, illustrate example XR systems that include AR and MR systems, in accordance with some embodiments. FIG. 10A shows a first XR system 1000a and first example user interactions using a wrist-wearable device 1026, a head-wearable device (e.g., HMD system 200, HMD system 250, and AR device 1028), and/or a HIPD 1042. FIG. 10B shows a second XR system 1000b and second example user interactions using a wrist-wearable device 1026, AR device 1028, and/or an HIPD 1042. FIGS. 10C-1 and 10C-2 show a third MR system 1000c and third example user interactions using a wrist-wearable device 1026, a head-wearable device (e.g., HMD system 200, HMD system 250, MR device 1032, etc., such as a VR device), and/or an HIPD 1042. As the skilled artisan will appreciate upon reading the descriptions provided herein, the above-example AR and MR systems (described in detail below) can perform various functions and/or operations.

The wrist-wearable device 1026, the head-wearable devices, and/or the HIPD 1042 can communicatively couple via a network 1025 (e.g., cellular, near field, Wi-Fi, personal area network, wireless LAN). Additionally, the wrist-wearable device 1026, the head-wearable device, and/or the HIPD 1042 can also communicatively couple with one or more servers 1030, computers 1040 (e.g., laptops, computers), mobile devices 1050 (e.g., smartphones, tablets), and/or other electronic devices via the network 1025 (e.g., cellular, near field, Wi-Fi, personal area network, wireless LAN). Similarly, a smart textile-based garment, when used, can also communicatively couple with the wrist-wearable device 1026, the head-wearable device(s), the HIPD 1042, the one or more servers 1030, the computers 1040, the mobile devices 1050, and/or other electronic devices via the network 1025 to provide inputs.

Turning to FIG. 10A, a user 1002 is shown wearing the wrist-wearable device 1026 and the AR device 1028 and having the HIPD 1042 on their desk. The wrist-wearable device 1026, the AR device 1028, and the HIPD 1042 facilitate user interaction with an AR environment. In particular, as shown by the first AR system 1000a, the wrist-wearable device 1026, the AR device 1028, and/or the HIPD 1042 cause presentation of one or more avatars 1004, digital representations of contacts 1006, and virtual objects 1008. As discussed below, the user 1002 can interact with the one or more avatars 1004, digital representations of the contacts 1006, and virtual objects 1008 via the wrist-wearable device 1026, the AR device 1028, and/or the HIPD 1042. In addition, the user 1002 is also able to directly view physical objects in the environment, such as a physical table 1029, through transparent lens(es) and waveguide(s) of the AR device 1028. Alternatively, an MR device could be used in place of the AR device 1028 and a similar user experience can take place, but the user would not be directly viewing physical objects in the environment, such as table 1029, and would instead be presented with a virtual reconstruction of the table 1029 produced from one or more sensors of the MR device (e.g., an outward facing camera capable of recording the surrounding environment).

The user 1002 can use any of the wrist-wearable device 1026, the AR device 1028 (e.g., through physical inputs at the AR device and/or built-in motion tracking of a user's extremities), a smart-textile garment, externally mounted extremity tracking device, the HIPD 1042 to provide user inputs, etc. For example, the user 1002 can perform one or more hand gestures that are detected by the wrist-wearable device 1026 (e.g., using one or more EMG sensors and/or IMUs built into the wrist-wearable device) and/or AR device 1028 (e.g., using one or more image sensors or cameras) to provide a user input. Alternatively, or additionally, the user 1002 can provide a user input via one or more touch surfaces of the wrist-wearable device 1026, the AR device 1028, and/or the HIPD 1042, and/or voice commands captured by a microphone of the wrist-wearable device 1026, the AR device 1028, and/or the HIPD 1042. The wrist-wearable device 1026, the AR device 1028, and/or the HIPD 1042 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1028 (e.g., via an input at a temple arm of the AR device 1028). In some embodiments, the user 1002 can provide a user input via one or more facial gestures and/or facial expressions. For example, cameras of the wrist-wearable device 1026, the AR device 1028, and/or the HIPD 1042 can track the user 1002's eyes for navigating a user interface.

The wrist-wearable device 1026, the AR device 1028, and/or the HIPD 1042 can operate alone or in conjunction to allow the user 1002 to interact with the AR environment. In some embodiments, the HIPD 1042 is configured to operate as a central hub or control center for the wrist-wearable device 1026, the AR device 1028, and/or another communicatively coupled device. For example, the user 1002 can provide an input to interact with the AR environment at any of the wrist-wearable device 1026, the AR device 1028, and/or the HIPD 1042, and the HIPD 1042 can identify one or more back-end and front-end tasks to cause the performance of the requested interaction and distribute instructions to cause the performance of the one or more back-end and front-end tasks at the wrist-wearable device 1026, the AR device 1028, and/or the HIPD 1042. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1042 can perform the back-end tasks and provide the wrist-wearable device 1026 and/or the AR device 1028 operational data corresponding to the performed back-end tasks such that the wrist-wearable device 1026 and/or the AR device 1028 can perform the front-end tasks. In this way, the HIPD 1042, which has more computational resources and greater thermal headroom than the wrist-wearable device 1026 and/or the AR device 1028, performs computationally intensive tasks and reduces the computer resource utilization and/or power usage of the wrist-wearable device 1026 and/or the AR device 1028.

In the example shown by the first AR system 1000a, the HIPD 1042 identifies one or more back-end tasks and front-end tasks associated with a user request to initiate an AR video call with one or more other users (represented by the avatar 1004 and the digital representation of the contact 1006) and distributes instructions to cause the performance of the one or more back-end tasks and front-end tasks. In particular, the HIPD 1042 performs back-end tasks for processing and/or rendering image data (and other data) associated with the AR video call and provides operational data associated with the performed back-end tasks to the AR device 1028 such that the AR device 1028 performs front-end tasks for presenting the AR video call (e.g., presenting the avatar 1004 and the digital representation of the contact 1006).

In some embodiments, the HIPD 1042 can operate as a focal or anchor point for causing the presentation of information. This allows the user 1002 to be generally aware of where information is presented. For example, as shown in the first AR system 1000a, the avatar 1004 and the digital representation of the contact 1006 are presented above the HIPD 1042. In particular, the HIPD 1042 and the AR device 1028 operate in conjunction to determine a location for presenting the avatar 1004 and the digital representation of the contact 1006. In some embodiments, information can be presented within a predetermined distance from the HIPD 1042 (e.g., within five meters). For example, as shown in the first AR system 1000a, virtual object 1008 is presented on the desk some distance from the HIPD 1042. Similar to the above example, the HIPD 1042 and the AR device 1028 can operate in conjunction to determine a location for presenting the virtual object 1008. Alternatively, in some embodiments, presentation of information is not bound by the HIPD 1042. More specifically, the avatar 1004, the digital representation of the contact 1006, and the virtual object 1008 do not have to be presented within a predetermined distance of the HIPD 1042. While an AR device 1028 is described working with an HIPD, an MR headset can be interacted with in the same way as the AR device 1028.

User inputs provided at the wrist-wearable device 1026, the AR device 1028, and/or the HIPD 1042 are coordinated such that the user can use any device to initiate, continue, and/or complete an operation. For example, the user 1002 can provide a user input to the AR device 1028 to cause the AR device 1028 to present the virtual object 1008 and, while the virtual object 1008 is presented by the AR device 1028, the user 1002 can provide one or more hand gestures via the wrist-wearable device 1026 to interact and/or manipulate the virtual object 1008. While an AR device 1028 is described working with a wrist-wearable device 1026, an MR headset can be interacted with in the same way as the AR device 1028.

Integration of Artificial Intelligence with XR Systems

FIG. 10A illustrates an interaction in which an artificially intelligent virtual assistant can assist in requests made by a user 1002. The AI virtual assistant can be used to complete open-ended requests made through natural language inputs by a user 1002. For example, in FIG. 10A the user 1002 makes an audible request 1044 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 10A also illustrates an example neural network 1052 used in Artificial Intelligence applications. Uses of Artificial Intelligence (AI) are varied and encompass many different aspects of the devices and systems described herein. AI capabilities cover a diverse range of applications and deepen interactions between the user 1002 and user devices (e.g., the AR device 1028, an MR device 1032, the HIPD 1042, the wrist-wearable device 1026). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1002 can interact with an AI model through natural language inputs captured by a voice sensor, text inputs, or any other input modality that accepts natural language and/or a corresponding voice sensor module. In another instance, input is provided by tracking the eye gaze of a user 1002 via a gaze tracker module. Additionally, the AI model can also receive inputs beyond those supplied by a user 1002. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 1028) or from multiple devices that are in communication with each other (e.g., a system that includes at least two of an AR device 1028, an MR device 1032, the HIPD 1042, the wrist-wearable device 1026, etc.). The AI model can also access additional information (e.g., one or more servers 1030, the computers 1040, the mobile devices 1050, and/or other electronic devices) via a network 1025.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1028, an MR device 1032, the HIPD 1042, the wrist-wearable device 1026) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1028, an MR device 1032, the HIPD 1042, the wrist-wearable device 1026), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1042), haptic feedback can provide information to the user 1002. An AI model can also use the inputs described above to determine the appropriate modality and device(s) to present content to the user (e.g., a user walking on a busy road can be presented with an audio output instead of a visual output to avoid distracting the user 1002).

### Example Augmented Reality Interaction

FIG. 10B shows the user 1002 wearing the wrist-wearable device 1026 and the AR device 1028 and holding the HIPD 1042. In the second AR system 1000b, the wrist-wearable device 1026, the AR device 1028, and/or the HIPD 1042 are used to receive and/or provide one or more messages to a contact of the user 1002. In particular, the wrist-wearable device 1026, the AR device 1028, and/or the HIPD 1042 detect and coordinate one or more user inputs to initiate a messaging application and prepare a response to a received message via the messaging application.

In some embodiments, the user 1002 initiates, via a user input, an application on the wrist-wearable device 1026, the AR device 1028, and/or the HIPD 1042 that causes the application to initiate on at least one device. For example, in the second AR system 1000b the user 1002 performs a hand gesture associated with a command for initiating a messaging application (represented by messaging user interface 1012); the wrist-wearable device 1026 detects the hand gesture; and, based on a determination that the user 1002 is wearing the AR device 1028, causes the AR device 1028 to present a messaging user interface 1012 of the messaging application. The AR device 1028 can present the messaging user interface 1012 to the user 1002 via its display (e.g., as shown by user 1002's field of view 1010). In some embodiments, the application is initiated and can be run on the device (e.g., the wrist-wearable device 1026, the AR device 1028, and/or the HIPD 1042) that detects the user input to initiate the application, and the device provides another device operational data to cause the presentation of the messaging application. For example, the wrist-wearable device 1026 can detect the user input to initiate a messaging application, initiate and run the messaging application, and provide operational data to the AR device 1028 and/or the HIPD 1042 to cause presentation of the messaging application. Alternatively, the application can be initiated and run at a device other than the device that detected the user input. For example, the wrist-wearable device 1026 can detect the hand gesture associated with initiating the messaging application and cause the HIPD 1042 to run the messaging application and coordinate the presentation of the messaging application.

Further, the user 1002 can provide a user input provided at the wrist-wearable device 1026, the AR device 1028, and/or the HIPD 1042 to continue and/or complete an operation initiated at another device. For example, after initiating the messaging application via the wrist-wearable device 1026 and while the AR device 1028 presents the messaging user interface 1012, the user 1002 can provide an input at the HIPD 1042 to prepare a response (e.g., shown by the swipe gesture performed on the HIPD 1042). The user 1002's gestures performed on the HIPD 1042 can be provided and/or displayed on another device. For example, the user 1002's swipe gestures performed on the HIPD 1042 are displayed on a virtual keyboard of the messaging user interface 1012 displayed by the AR device 1028.

In some embodiments, the wrist-wearable device 1026, the AR device 1028, the HIPD 1042, and/or other communicatively coupled devices can present one or more notifications to the user 1002. The notification can be an indication of a new message, an incoming call, an application update, a status update, etc. The user 1002 can select the notification via the wrist-wearable device 1026, the AR device 1028, or the HIPD 1042 and cause presentation of an application or operation associated with the notification on at least one device. For example, the user 1002 can receive a notification that a message was received at the wrist-wearable device 1026, the AR device 1028, the HIPD 1042, and/or other communicatively coupled device and provide a user input at the wrist-wearable device 1026, the AR device 1028, and/or the HIPD 1042 to review the notification, and the device detecting the user input can cause an application associated with the notification to be initiated and/or presented at the wrist-wearable device 1026, the AR device 1028, and/or the HIPD 1042.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1028 can present to the user 1002 game application data and the HIPD 1042 can use a controller to provide inputs to the game. Similarly, the user 1002 can use the wrist-wearable device 1026 to initiate a camera of the AR device 1028, and the user can use the wrist-wearable device 1026, the AR device 1028, and/or the HIPD 1042 to manipulate the image capture (e.g., zoom in or out, apply filters) and capture image data.

While an AR device 1028 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 10C-1 and 10C-2, the user 1002 is shown wearing the wrist-wearable device 1026 and an MR device 1032 (e.g., a device capable of providing either an entirely VR experience or an MR experience that displays object(s) from a physical environment at a display of the device) and holding the HIPD 1042. In the third AR system 1000c, the wrist-wearable device 1026, the MR device 1032, and/or the HIPD 1042 are used to interact within an MR environment, such as a VR game or other MR/VR application. While the MR device 1032 presents a representation of a VR game (e.g., first MR game environment 1020) to the user 1002, the wrist-wearable device 1026, the MR device 1032, and/or the HIPD 1042 detect and coordinate one or more user inputs to allow the user 1002 to interact with the VR game.

In some embodiments, the user 1002 can provide a user input via the wrist-wearable device 1026, the MR device 1032, and/or the HIPD 1042 that causes an action in a corresponding MR environment. For example, the user 1002 in the third MR system 1000c (shown in FIG. 10C-1) raises the HIPD 1042 to prepare for a swing in the first MR game environment 1020. The MR device 1032, responsive to the user 1002 raising the HIPD 1042, causes the MR representation of the user 1022 to perform a similar action (e.g., raise a virtual object, such as a virtual sword 1024). In some embodiments, each device uses respective sensor data and/or image data to detect the user input and provide an accurate representation of the user 1002's motion. For example, image sensors (e.g., SLAM cameras or other cameras) of the HIPD 1042 can be used to detect a position of the HIPD 1042 relative to the user 1002's body such that the virtual object can be positioned appropriately within the first MR game environment 1020; sensor data from the wrist-wearable device 1026 can be used to detect a velocity at which the user 1002 raises the HIPD 1042 such that the MR representation of the user 1022 and the virtual sword 1024 are synchronized with the user 1002's movements; and image sensors of the MR device 1032 can be used to represent the user 1002's body, boundary conditions, or real-world objects within the first MR game environment 1020.

In FIG. 10C-2, the user 1002 performs a downward swing while holding the HIPD 1042. The user 1002's downward swing is detected by the wrist-wearable device 1026, the MR device 1032, and/or the HIPD 1042 and a corresponding action is performed in the first MR game environment 1020. In some embodiments, the data captured by each device is used to improve the user's experience within the MR environment. For example, sensor data of the wrist-wearable device 1026 can be used to determine a speed and/or force at which the downward swing is performed and image sensors of the HIPD 1042 and/or the MR device 1032 can be used to determine a location of the swing and how it should be represented in the first MR game environment 1020, which, in turn, can be used as inputs for the MR environment (e.g., game mechanics, which can use detected speed, force, locations, and/or aspects of the user 1002's actions to classify a user's inputs (e.g., user performs a light strike, hard strike, critical strike, glancing strike, miss) or calculate an output (e.g., amount of damage)).

FIG. 10C-2 further illustrates that a portion of the physical environment is reconstructed and displayed at a display of the MR device 1032 while the MR game environment 1020 is being displayed. In this instance, a reconstruction of the physical environment 1046 is displayed in place of a portion of the MR game environment 1020 when object(s) in the physical environment are potentially in the path of the user (e.g., a collision with the user and an object in the physical environment are likely). Thus, this example MR game environment 1020 includes (i) an immersive VR portion 1048 (e.g., an environment that does not have a corollary counterpart in a nearby physical environment) and (ii) a reconstruction of the physical environment 1046 (e.g., table 1050 and cup 1052). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1026, the MR device 1032, and/or the HIPD 1042 are described as detecting user inputs, in some embodiments, user inputs are detected at a single device (with the single device being responsible for distributing signals to the other devices for performing the user input). For example, the HIPD 1042 can operate an application for generating the first MR game environment 1020 and provide the MR device 1032 with corresponding data for causing the presentation of the first MR game environment 1020, as well as detect the user 1002's movements (while holding the HIPD 1042) to cause the performance of corresponding actions within the first MR game environment 1020. Additionally or alternatively, in some embodiments, operational data (e.g., sensor data, image data, application data, device data, and/or other data) of one or more devices is provided to a single device (e.g., the HIPD 1042) to process the operational data and cause respective devices to perform an action associated with processed operational data.

In some embodiments, the user 1002 can wear a wrist-wearable device 1026, wear an MR device 1032, wear smart textile-based garments 1038 (e.g., wearable haptic gloves), and/or hold an HIPD 1042 device. In this embodiment, the wrist-wearable device 1026, the MR device 1032, and/or the smart textile-based garments 1038 are used to interact within an MR environment (e.g., any AR or MR system described above in reference to FIGS. 10A-10B). While the MR device 1032 presents a representation of an MR game (e.g., second MR game environment 1020) to the user 1002, the wrist-wearable device 1026, the MR device 1032, and/or the smart textile-based garments 1038 detect and coordinate one or more user inputs to allow the user 1002 to interact with the MR environment.

In some embodiments, the user 1002 can provide a user input via the wrist-wearable device 1026, an HIPD 1042, the MR device 1032, and/or the smart textile-based garments 1038 that causes an action in a corresponding MR environment. In some embodiments, each device uses respective sensor data and/or image data to detect the user input and provide an accurate representation of the user 1002's motion. While four different input devices are shown (e.g., a wrist-wearable device 1026, an MR device 1032, an HIPD 1042, and a smart textile-based garment 1038) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1038) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 1038 can be used in conjunction with an MR device and/or an HIPD 1042.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for case of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 10A-10C-2 provided above are intended to augment the description provided in reference to FIGS. 1-9. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. An extended-reality (XR) system, comprising:
one or more processors communicatively coupled with:
a head-wearable device for presenting a virtual object to a user of the head-wearable device, and
one or more sensors for detecting user motion data; and
memory including executable instructions that, when executed by the one or more processors, cause the one or more processors to perform:
causing, at a first point in time, presentation of the virtual object by successively displaying a plurality of color fields including presenting a first color field at a first display position of the head-wearable device and a second color field at the first display position of the head-wearable device so that the virtual object is at a world-locked location as viewed by the user from a first perspective; and
in accordance with a determination, based on the user motion data, that misalignment criteria are satisfied for the virtual object:
causing, at a second point in time, presentation of the virtual object by successively displaying the plurality of color fields including presenting one or more of the first color field and the second color field of the virtual object at a second display position of the head-wearable device, distinct from the first display position, so that the virtual object is at the world-locked location as viewed by the user from a second perspective.

2. The XR system of claim 1, wherein:
the plurality of color fields includes a third color field;
causing, at the first point in time, the presentation of the virtual object by successively displaying the plurality of color fields includes presenting i) the first color field at the first display position of the head-wearable device, ii) the second color field at the first display position of the head-wearable device, and iii) the third color field at the first display position of the head-wearable device so that the virtual object is at the world-locked location as viewed by the user from the first perspective; and
causing, at the second point in time, the presentation of the virtual object by successively displaying the plurality of color fields includes presenting one or more of the first color field, the second color field, and the third color filed at the second display position of the head-wearable device so that the virtual object is at the world-locked location as viewed by the user from a second perspective.

3. The XR system of claim 2, wherein:
the plurality of color fields includes a fourth color field;
causing, at the first point in time, the presentation of the virtual object by successively displaying the plurality of color fields includes presenting i) the first color field at the first display position of the head-wearable device, ii) the second color field at the first display position of the head-wearable device, iii) the third color field at the first display position of the head-wearable device, and iv) the fourth color field at the first display position of the head-wearable device so that the virtual object is at the world-locked location as viewed by the user from the first perspective; and
causing, at the second point in time, the presentation of the virtual object by successively displaying the plurality of color fields includes presenting one or more of the first color field, the second color field, the third color field, and the fourth color field at the second display position of the head-wearable device so that the virtual object is at the world-locked location as viewed by the user from a second perspective.

4. The XR system of claim 1, wherein the instructions, when executed by the one or more processors, cause the one or more processors to further perform:
in accordance with a determination, based on additional user motion data, that misalignment criteria are satisfied for the virtual object:
causing, at a third point in time, presentation of the virtual object by successively displaying the plurality of color fields including presenting one or more of the first color field and the second color field of the virtual object at a third display position of the head-wearable device so that the virtual object is at the world-locked location as viewed by the user from a third perspective.

5. The XR system of claim 1, wherein each color field of the plurality of color fields is a distinct visible colors.

6. The XR system of claim 1, wherein the instructions, when executed by the one or more processors, cause the one or more processors to further perform:
determining the second display position of the head-wearable device based on, at least, the first display position of the head-wearable device and the user motion data.

7. The XR system of claim 1, wherein the user motion data includes one or more of a head movement and an eye movement.

8. The XR system of claim 1, wherein the misalignment criteria includes one or more of an eye movement above a predetermined eye-movement threshold, a head movement above a predetermined head-movement threshold, and a combination thereof.

9. The XR system of claim 1, wherein the first display position of the head-wearable device and the second display position of the head-wearable device align the virtual object as viewed by the user from a second perspective.

10. The XR system of claim 1, wherein the virtual object is presented as part of an XR environment including one of an augmented-reality environment or mixed-reality environment that includes a visual of the user's real-world surroundings.

11. The XR system of claim 1, wherein the head-wearable device is augmented-reality glasses or mixed-reality glasses.

12. A method, comprising:
at a first point in time, causing a head-wearable device to present a virtual object by successively displaying a plurality of color fields including presenting a first color field at a first display position of the head-wearable device and a second color field at the first display position of the head-wearable device so that the virtual object is at a world-locked location as viewed by the user from a first perspective; and
in accordance with a determination, based on user motion data obtained via one or more sensors, that misalignment criteria are satisfied for the virtual object:
at a second point in time, causing the head-wearable device to present the virtual object by successively displaying the plurality of color fields including presenting one or more of the first color field and the second color field of the virtual object at a second display position of the head-wearable device, distinct from the first display position, so that the virtual object is at the world-locked location as viewed by the user from a second perspective.

13. The method of claim 12, wherein:
the plurality of color fields includes a third color field;
causing, at the first point in time, the presentation of the virtual object by successively displaying the plurality of color fields includes presenting i) the first color field at the first display position of the head-wearable device, ii) the second color field at the first display position of the head-wearable device, and iii) the third color field at the first display position of the head-wearable device so that the virtual object is at the world-locked location as viewed by the user from the first perspective; and
causing, at the second point in time, the presentation of the virtual object by successively displaying the plurality of color fields includes presenting one or more of the first color field, the second color field, and the third color filed at the second display position of the head-wearable device so that the virtual object is at the world-locked location as viewed by the user from a second perspective.

14. The method of claim 13, wherein:
the plurality of color fields includes a fourth color field;
causing, at the first point in time, the presentation of the virtual object by successively displaying the plurality of color fields includes presenting i) the first color field at the first display position of the head-wearable device, ii) the second color field at the first display position of the head-wearable device, iii) the third color field at the first display position of the head-wearable device, and iv) the fourth color field at the first display position of the head-wearable device so that the virtual object is at the world-locked location as viewed by the user from the first perspective; and
causing, at the second point in time, the presentation of the virtual object by successively displaying the plurality of color fields includes presenting one or more of the first color field, the second color field, the third color field, and the fourth color field at the second display position of the head-wearable device so that the virtual object is at the world-locked location as viewed by the user from a second perspective.

15. The method of claim 12, further comprising:
in accordance with a determination, based on additional user motion data, that misalignment criteria are satisfied for the virtual object:
causing, at a third point in time, presentation of the virtual object by successively displaying the plurality of color fields including presenting one or more of the first color field and the second color field of the virtual object at a third display position of the head-wearable device so that the virtual object is at the world-locked location as viewed by the user from a third perspective.

16. The method of claim 12, further comprising:
determining the second display position of the head-wearable device based on, at least, the first display position of the head-wearable device and the user motion data.

17. A non-transitory computer readable storage medium including instructions that, when executed by a computing device, cause the computing device to perform:
at a first point in time, causing a head-wearable device to present a virtual object by successively displaying a plurality of color fields including presenting a first color field at a first display position of the head-wearable device and a second color field at the first display position of the head-wearable device so that the virtual object is at a world-locked location as viewed by the user from a first perspective; and
in accordance with a determination, based on user motion data obtained via one or more sensors, that misalignment criteria are satisfied for the virtual object:
at a second point in time, causing the head-wearable device to present of the virtual object by successively displaying the plurality of color fields including presenting one or more of the first color field and the second color field of the virtual object at a second display position of the head-wearable device so that the virtual object is at the world-locked location as viewed by the user from a second perspective.

18. The non-transitory computer readable storage medium of claim 17, wherein:
the plurality of color fields includes a third color field;
causing, at the first point in time, the presentation of the virtual object by successively displaying the plurality of color fields includes presenting i) the first color field at the first display position of the head-wearable device, ii) the second color field at the first display position of the head-wearable device, and iii) the third color field at the first display position of the head-wearable device so that the virtual object is at the world-locked location as viewed by the user from the first perspective; and
causing, at the second point in time, the presentation of the virtual object by successively displaying the plurality of color fields includes presenting one or more of the first color field, the second color field, and the third color filed at the second display position of the head-wearable device so that the virtual object is at the world-locked location as viewed by the user from a second perspective.

19. The non-transitory computer readable storage medium of claim 18, wherein:
the plurality of color fields includes a fourth color field;
causing, at the first point in time, the presentation of the virtual object by successively displaying the plurality of color fields includes presenting i) the first color field at the first display position of the head-wearable device, ii) the second color field at the first display position of the head-wearable device, iii) the third color field at the first display position of the head-wearable device, and iv) the fourth color field at the first display position of the head-wearable device so that the virtual object is at the world-locked location as viewed by the user from the first perspective; and
causing, at the second point in time, the presentation of the virtual object by successively displaying the plurality of color fields includes presenting one or more of the first color field, the second color field, the third color field, and the fourth color field at the second display position of the head-wearable device so that the virtual object is at the world-locked location as viewed by the user from a second perspective.

20. The non-transitory computer readable storage medium of claim 17, further comprising:
in accordance with a determination, based on additional user motion data, that misalignment criteria are satisfied for the virtual object:
causing, at a third point in time, presentation of the virtual object by successively displaying the plurality of color fields including presenting one or more of the first color field and the second color field of the virtual object at a third display position of the head-wearable device so that the virtual object is at the world-locked location as viewed by the user from a third perspective.
